(19) United States
(12) Patent Application Publication
(10) Pub. No.: US 2012/0080276 A1
(43) Pub. Date: Apr. 5, 2012

(54) NOISE-DAMPING FRICTION PADS

(76) Inventors: Stewart Kahan, Dollard Des Ormeaux (CA); Ken Schouten, Vaudreuil-Dorion (CA); Seong Kwan Rhee, Northville, MI (US)

(21) Appl. No.: 13/250,252

(22) Filed: Sep. 30, 2011

(30) Foreign Application Priority Data
Oct. 1, 2010 (CA) 2,716,139

(51) Int. Cl. F16D 65/092

(52) U.S. Cl. 188/73.1; 188/250 B

(57) ABSTRACT

The invention provides a noise-damping friction pad system, and the use of such a system in disc brakes, where the coefficient of friction of the outer friction pad differs by at least 2% from the coefficient of friction of the inner friction pad to reduce brake squeal noise. The inner friction pad and outer friction pad may each comprise at least one cross slot though the surface of each pad that is not in contact with the backing plates to further reduce brake squeal noise. The friction pads may be made of a ceramic composition a lomet composition, or one friction pad may be made of a ceramic composition and the other friction pad made of a lomet composition.

### FIELD OF THE INVENTION

The invention relates to automotive brakes, and more particularly relates to noise-damping friction pads for disc brake systems.

### BACKGROUND OF THE INVENTION

In a disc brake caliper, a hydraulically actuated piston forces, by action and reaction, a pair of opposing brake pads to pinch a rotor attached to, and rotating with, a vehicle wheel. Each brake pad consists of a stiff backing plate with a friction pad affixed to the inner side of the plate. The backing plate of the outer brake pad is attached to the caliper housing. The backing plate of the inner brake pad is proximate to the piston so that the piston, when actuated, moves the brake pads towards each other so that the friction pads engage the friction surfaces of the rotor such that the resulting frictional forces reduce the rotational speed of the rotor, and hence wheel.

Various types of noise may be produced by disc brakes. Brake noise is an expensive problem for car and brake manufacturers as customers invariably want the noise remedied under warranty, even though the noise has no impact on the proper operation of the brakes to stop the car.

Low frequency noise, sometimes referred to as groan, moan, wire brush or crunch, may be caused by vibration of the suspension components. Such low frequently noise is generally less than 500 Hz.

High frequency noise, or squeal, may be much more annoying. As the coefficient of friction of the friction pads increases, the stopping power of the brakes increases, but the pads introduce higher and higher vibration energy to the brake system, which eventually leads to brake squeal when the brake pads and the rotor are synchronized (coupled) in vibration modes and frequencies. Such noise is typically in the range of 2,000 to 20,000 Hz.

### SUMMARY OF THE INVENTION

The invention is directed to a system of noise-damping friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad is at least 2% greater than the coefficient of friction of the inner friction pad. The invention also includes the use of a lower-friction friction pad and a higher-friction friction pad in a disc brake having an inner brake pad and an outer brake pad, where the coefficient of friction of the lower-friction friction pad is at least 2% less than the coefficient of friction of the higher-friction friction pad, wherein the higher-friction friction pad may be placed in the outer brake pad and the lower-friction friction pad placed in the inner brake pad.

In some embodiments, the coefficient of friction of the outer friction pad may be at least 6% greater than the coefficient of friction of the inner friction pad.

The friction pads may be made of a ceramic composition, a lomet composition, or one friction pad may be made of a ceramic composition and the other friction pad made of a lomet composition.

The invention also provides for a system of noise-damping friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad is at least 2% less than the coefficient of friction of the inner friction pad, and the coefficient of friction of the outer friction pad may be no more than 6% less than the coefficient of friction of the inner friction pad. The invention also includes the use of a lower-friction friction pad and a higher-friction friction pad in a disc brake having an inner brake pad and an outer brake pad, where the coefficient of friction of the lower-friction friction pad is at least 2% less than the coefficient of friction of the higher-friction friction pad, and the coefficient of friction of the lower-friction friction pad may be no more than 6% less than the coefficient of friction of the higher-friction friction pad, wherein the higher-friction friction pad may be placed in the inner brake pad and the lower-friction friction pad may be placed in the outer brake pad.

The invention also provides for a system of noise-damping friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad differs by at least 2% from the coefficient of friction of the inner friction pad, and wherein the inner friction pad and outer friction pad may each comprise at least one cross slot though the surface of each pad that is not in contact with the backing plates. The coefficient of friction of the outer friction pad may differ by at least 6% from the coefficient of friction of the inner friction pad.

Each friction pad may include two cross slots and each cross slot may be at an angle of 10-80 degrees with respect to the vertical and horizontal axes of the friction pad. The two cross-slots on each friction pad may intersect each other near the center of the friction pad. Each cross slot may be at an angle of at least 10 degrees with respect to the diagonal axes of the friction pad. Alternatively each cross slot may be at an angle of 25-65 degrees with respect to the vertical and horizontal axes of the friction pad and each cross slot may be at an angle of at least 20 degrees with respect to the diagonal axes of the friction pad. Each cross slot may comprise a V-shaped portion.

### BRIEF DESCRIPTION OF THE DRAWINGS

FIG. 1 shows a cross-section of a brake caliper and piston assembly employing noise-damping friction pads.

FIG. 2 shows a perspective view of one brake pad.

FIG. 3 shows a top view of one brake pad.

FIG. 4 shows a side view of the side of a friction pad that does not contact a backing plate, with dashed lines depicting the axes of the friction pad.

### DETAILED DESCRIPTION

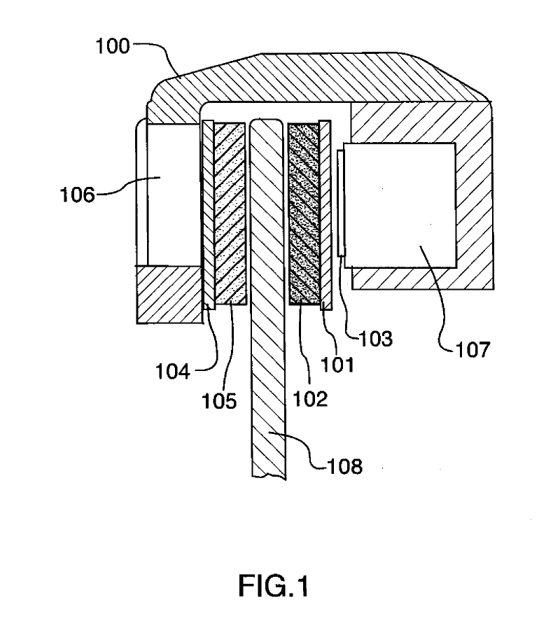

FIG. 1 shows a sectioned brake caliper 100 with an inner brake pad and an outer brake pad mounted thereto. The inner brake pad comprises a backing plate 101 which has a bonded friction pad 102 adjacent to the brake rotor 108. The outer brake pad comprises a backing plate 104 which has a bonded friction pad 105 adjacent to the caliper forcing member, or caliper finger, 106.

The caliper piston 103 slideably fits in the caliper cylinder 107 which is part of the caliper 100. The caliper 100 slideably connects to a caliper carrier and to a vehicle's suspension system via bosses (not shown). When the brake is applied, the piston 103 is forced from the cylinder 107, and, simultaneously, the caliper 100 is made to slide on caliper pins (not shown). This action causes the caliper forcing member 106 and piston 103 to approach each other, forcing the two opposing friction pads 102, 105 to pinch the rotor 108 thereby slowing its rotation because of the resulting friction.

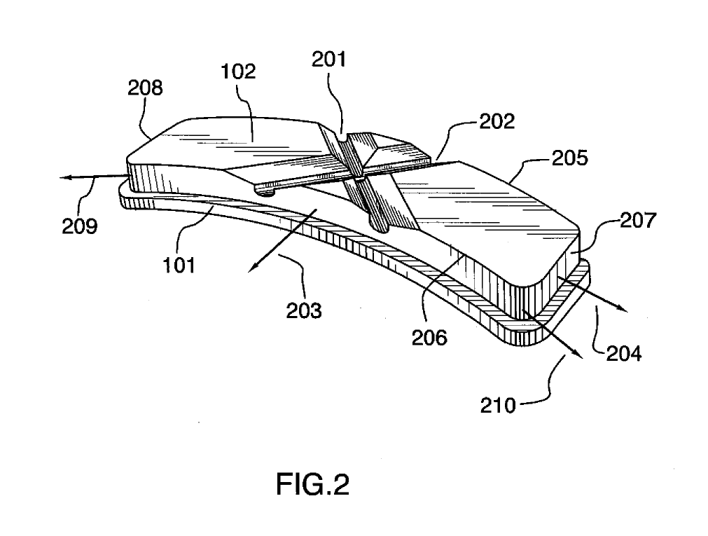

High-frequency brake noise, or squeal, occurs when the brake pads and the rotor 108 are synchronized (coupled) in vibration modes and frequencies. If they go out of synchronization, the squeal becomes quieter or may be eliminated. The inventors have discovered that such noise damping may be achieved by the use of compositions of materials with different coefficients of friction in the inner and outer friction pads, which may be used in combination with X-slots, or cross slots, 201, 202 in the friction pads 102, 105 (as shown in FIG. 2). When the coefficients of friction of the friction pads 102, 105 used in the two brake pads differ, synchronization of the vibration modes of the two brake pads becomes unlikely.

Generally, synchronization of the pads may be avoided by choosing compositions of materials for the friction pads 102, 105 so that the coefficient of friction of one friction pad 102, 105 is at least 2% higher than the coefficient of friction of the other friction pad 105, 102. Preferably, the coefficient of friction of one friction pad 102, 105 is at least 3% higher than the coefficient of friction of the other friction pad 105, 102. In some cases, it may be preferred that the coefficient of friction of one friction pad 102, 105 be at least 5-6% higher than the coefficient of friction of the other friction pad 105, 102. Alternatively it may be preferred that the coefficient of friction of the outer friction pad 105 differ from the coefficient of friction of the inner friction pad 102 by at least 10%.

For example, if the coefficient of friction of the outer friction pad 105 is 0.40, then the inner friction pad 102 may be made to have a coefficient of friction 2% to 6% higher, or 0.41 to 0.42. Other alternatives such as a 3-6% difference are also possible.

As another example, if the coefficient of friction of the outer friction pad 105 is 0.40, then the inner friction pad 102 may be made to have a coefficient of friction that is at least 2% lower, or 0.39 or less. In another embodiment, the inner friction pad 102 may be made to have a coefficient of friction that is at least 3% lower. Alternatively, the inner friction pad 102 may be made to have a coefficient of friction that is at least 6% or 10% lower.

Both friction pads 102, 105 may be made of a ceramic composition, which may be referred to as a ceramic-ceramic pair. Ceramic formulations are widely used in Japan and North America so that many such formulations are well known in the art. Table 1 shows typical ranges of ingredients that may be used in a ceramic formulation.

TABLE 1

| | Ingredient |
|---|---|
| Ingredient | Range (wt %) |
| Metal fiber/powder | 5-20 |
| Resin powder | 5-20 |
| Carbonaceous powder | 6-24 |
| Abrasives powder | 6-25 |
| Filler powder | 10-30 |
| Solid lubricants | 1-15 |
| Organic fibers | 1-6 |

The friction coefficient of such a ceramic friction pad can be increased by increasing the abrasives concentration while reducing fillers and lubricants, or the friction coefficient can be reduced by decreasing the abrasives concentration while increasing the filler and lubricant concentrations.

Alternatively, the friction pads 102, 105 may be made of two compositions with a low metal concentration, commonly referred to as “lomet”, of differing friction, or of one lomet and one ceramic composition, which may be referred to as a lomet-lomet pair and a lomet-ceramic pair respectively. Lomet formulations are widely used in Europe and to a lesser extent in North America, so that many such formulations are well known in the art. Table 2 shows typical ranges of ingredients that may be used in a lomet formulation.

TABLE 2

| | Ingredient |
|---|---|
| Ingredient | Range (wt %) |
| Metal fiber/powder | 20-45 |
| Resin powder | 5-20 |
| Carbonaceous powder | 6-24 |
| Abrasives powder | 8-28 |
| Filler powder | 5-15 |
| Solid lubricants | 2-15 |
| Organic fibers | 1-5 |

Because of the potential variability between batches of compositions used as the basis for the friction pads, each pair of inner and outer friction pads, where the pair are based on the same material, such as in a ceramic-ceramic or lomet-lomet pair, should be manufactured using the same batch of material as a starting point to ensure that the difference in the coefficients of friction can be controlled.

In addition to keeping the brake pads out of synchronization with each other, in order to better prevent or reduce squeal, the pads should be kept out of synchronization with the rotor 108. The inventors have discovered that this can be done by the use of large cross slots 201, 202 in the surface of each friction pad 102, 105 that contacts the rotor 108 (i.e. the surface of the friction pad 102, 105 that is not in contact with the corresponding backing plate 101, 104), an example of which is shown in FIGS. 2-4. The cross slots 201, 202, through the surfaces of the friction pads 102, 105 that are not in contact with the backing plates 101, 104, change the vibration modes of the pads away from the rotor 108 vibration modes. Often, brake squeal is caused by the two sides (the leading side 207 and trailing side 208 as shown in FIG. 2) of the friction pad 102, 105 vibrating (or flapping) along the vertical axis 203, which runs from the outer edge 205 of the friction pad 102, 105 to the inner edge 206 of the friction pad 102, 105. This vibration mode is referred to as the first bending mode of vibration. Squeal may also be caused by the four corners of a pad vibrating along the corner-to-corner diagonal axes 209, 210, in what may be referred to as a twisting mode of vibration. The cross slots 201, 202 reduce the bending mode and twisting mode of vibration, thus reducing brake squeal. The cross slots 201, 202 also facilitate rapid wear debris removal, which also facilitates noise reduction.

FIG. 2 shows an example of one embodiment of an inner brake pad including an inner friction pad 102 attached to an inner backing plate 101. The corresponding outer brake pad may be identical to the inner brake pad, with the exception of the coefficient of friction of the friction pad 105, as discussed above, or the material used to make the friction pad 105, as discussed below. However, it is not essential that the configurations of the cross slots 201, 202 be identical or similar and they may be displaced relative to each other.

In some embodiments the cross slots 201, 202 may be purposely made to be in differing configurations on the inner and outer friction pads 102, 105. For example, the intersection point of the slots may differ by 5-10% or more in distance from the edges of the pads. This may improve the performance of the brake system by decreasing the likelihood of synchronization of the vibration modes of the pads and hence reduce the likelihood and amount of squeal that may be produced.

A vertical slot in the middle of a pad coming straight down parallel to the vertical axis 203 from the outer edge 205 of the friction pad 102 to the inner edge 206 of the friction pad 102 would promote the first bending mode of the pad for vibration, which leads to brake squeal. This may be avoided by ensuring that the cross slots 201, 202 are at least 10 degrees, and preferably 45 degrees, away from the vertical axis 203. Similarly the cross slots 201, 202 should be at least 10 degrees, and preferably 45 degrees, away from the horizontal axis 204 to avoid vibration due to horizontal bending.

The next most frequently encountered vibration of the pad is a first twisting mode, in which the pad bends along the diagonal axis 209 that runs from the lower left corner to the upper right corner of the pad (as shown in FIG. 4), and also along the diagonal axis 210 that runs from the upper left corner of the pad to the lower right corner of the pad. This may be avoided by ensuring that the right cross slot 202 is at least 10 degrees, and preferably 20-30 degrees, away from the first diagonal axis 209, and that the left cross slot 201 is at least 10 degrees, and preferably 20-30 degrees, away from the second diagonal axis 210.

The cross slots 201, 202 reduce these two most common modes of vibration of a pad, thus reducing the squeal tendency of a disc brake system. In the embodiment shown in FIGS. 2-4, the cross slots are approximately 45 degrees away from the vertical axis 203 and horizontal axis 204, and the left and right cross slots 202, 201 are about 20 degrees away from the first and second diagonal axes 209, 210 respectively.

The cross slots 201, 202 of the present invention are placed at an angle relative to the vertical axis 203 and horizontal axis 204 of the pad and run from the outer edge 205 of the friction pad 102 to the inner edge 206 of the friction pad 102, typically intersecting each other near the center of the friction pad 102 as shown in FIGS. 2 and 4, although intersecting each other near the center is not essential. Preferably the cross slots 201, 202 are placed at an angle of between 25 and 65 degrees relative to both the vertical axis 203 and horizontal axis 204 and more preferably at an angle of about 45 degrees relative to both the vertical axis 203 and horizontal axis 204. Preferably the cross slots 201, 202 are at least 10 degrees, and preferably at least 20 degrees, away from the diagonal axes 209, 210.

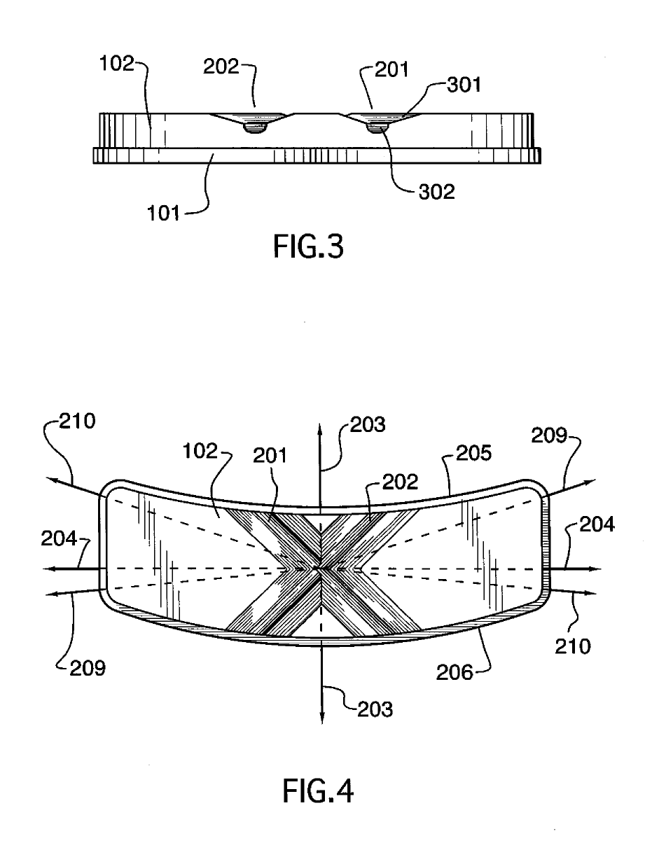

In some embodiments of the invention, as seen best in the top view of an inner brake pad depicted in FIG. 3, each cross slot 201, 202 may have an upper V-shaped portion 301, and a lower U-shaped portion 302. The U-shaped portion 302 may be 2-4 millimetres in width for example, and the V-shaped portion 301 may span 15-20 millimetres at the surface of the friction pad 102, decreasing to the width of the U-shaped portion 302 where the V-shaped portion 301 meets the U-shaped portion 302.

The specific configuration of the slots, such as the slope of the V-shaped portion 301 and location of the intersection point, may be selected for decorative or ornamental purposes to make the pads attractive to potential purchasers.

The slots will not generally extend through the entire thickness of the friction pad 102, 105 and may be designed to provide a remaining pad thickness at the bottom of each cross slot 201, 202 of 2-7 millimetres depending on the size of the friction pad 102, 105.

The above numbers are provided by way of example only. The actual numbers will vary between embodiments due to many factors, such as the overall size of the pad. The above numbers may be representative of an embodiment of a friction pad 102 with a length of about 150 millimetres, a height of about 55 millimetres and a friction pad thickness of about 12 millimetres. The actual size of the pads can vary widely depending on the size of the rotor 108 and other factors known to persons skilled in the art.

Alternative embodiments may employ a single cross slot or more than two cross slots, although two cross slots are preferred.

In addition, the performance of the brake system make be enhanced by making the surface area of the inner and outer pads different by, for example, at least 2%. For example the outer friction pad 105 may be 20% larger in area (i.e. the area of the surface of the pad that contacts the rotor 108) than the inner friction pad 102, or alternatively the inner friction pad 102 may be 20% larger in area that the outer friction pad 105. This may improve the performance of the brake system by decreasing the likelihood of synchronization of the vibration modes of the pads and hence reduce the likelihood and amount of squeal that may be produced.

In general, methods for attaching friction pads 102, 105 to backing plates 101, 104 are well known in the art and any usual method may be employed to place a friction pad 102, 105 in a brake pad.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

What is claimed is:

1. A system of friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad is at least 2% greater than the coefficient of friction of the inner friction pad.

2. The system of claim 1 wherein the coefficient of friction of the outer friction pad is at least 6% greater than the coefficient of friction of the inner friction pad.

3. The system of claim 1 wherein the friction pads are made of a ceramic composition.

4. The system of claim 1 wherein the friction pads are made of a lomet composition.

5. The system of claim 1 wherein one friction pad is made of a ceramic composition and the other friction pad is made of a lomet composition.

6. The use of a lower-friction friction pad and a higher-friction friction pad in a disc brake having an inner brake pad and an outer brake pad, where the coefficient of friction of the lower-friction friction pad is at least 2% less than the coefficient of friction of the higher-friction friction pad, wherein the higher-friction friction pad is placed in the outer brake pad and the lower-friction friction pad is placed in the inner brake pad.

7. A system of friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad is at least 2% less than the coefficient of friction of the inner friction pad, and the coefficient of friction of the outer friction pad is no more than 6% less than the coefficient of friction of the inner friction pad.

8. The system of claim 7 wherein the friction pads are made of a ceramic composition.

9. The system of claim 7 wherein the friction pads are made of a lomet composition.

10. The system of claim 7 wherein one friction pad is made of a ceramic composition and the other friction pad is made of a lomet composition.

11. The use of a lower-friction friction pad and a higher-friction friction pad in a disc brake having an inner brake pad and an outer brake pad, where the coefficient of friction of the lower-friction friction pad is at least 2% less than the coefficient of friction of the higher-friction friction pad, and the coefficient of friction of the lower-friction friction pad is no more than 6% less than the coefficient of friction of the higher-friction friction pad, wherein the higher-friction friction pad is placed in the inner brake pad and the lower-friction friction pad is placed in the outer brake pad.

12. A system of friction pads for use in a disc brake having an inner brake pad and an outer brake pad, the system comprising an inner friction pad for use in the inner brake pad by attachment to an inner backing plate, and an outer friction pad for use in the outer brake pad by attachment to an outer backing plate, wherein the coefficient of friction of the outer friction pad differs by at least 2% from the coefficient of friction of the inner friction pad, and wherein the inner friction pad and outer friction pad each comprise at least one cross slot though the surface of each friction pad that is not in contact with the backing plates.

13. The system of claim 12 wherein the coefficient of friction of the outer friction pad differs by at least 6% from the coefficient of friction of the inner friction pad.

14. The system of claim 12 comprising two cross slots, each cross slot being at an angle of 10-80 degrees with respect to the vertical and horizontal axes of the friction pad.

15. The system of claim 14 wherein the two cross-slots on each friction pad intersect each other and the location of the intersection point relative to the edges of the friction pads differs by at least 2% between the inner and outer friction pads.

16. The system of claim 15 wherein the location of the intersection point relative to the edges of the friction pads differs by at least 10% between the inner and outer friction pads.

17. The system of claim 14 wherein the two cross-slots on each friction pad intersect each other near the center of the friction pad.

18. The system of claim 14 wherein each cross slot is at an angle of at least 10 degrees with respect to the diagonal axes of the friction pad.

19. The system of claim 18 wherein each cross slot is at an angle of 25-65 degrees with respect to the vertical and horizontal axes of the friction pad, and each cross slot is at an angle of at least 20 degrees with respect to the diagonal axes of the friction pad.

20. The system of claim 12 wherein the friction pads are made of a ceramic composition.

21. The system of claim 12 wherein the friction pads are made of a lomet composition.

22. The system of claim 12 wherein one friction pads is made of a ceramic composition and the other friction pad is made of a lomet composition.

23. The system of claim 12 wherein each cross slot comprises a V-shaped portion.
